(19) United States
(12) Patent Application Publication
(10) Pub. No.: US 2026/0358937 A1
(43) Pub. Date: Nov. 12, 2026

(54) INTERACTION METHOD, ELECTRONIC DEVICE, STORAGE MEDIUM, AND PROGRAM PRODUCT

(71) Applicant: Beijing Zitiao Network Technology Co., Ltd., Beijing (CN)

(72) Inventor: Yingze YAO, Beijing (CN)

(21) Appl. No.: 19/489,837

(22) PCT Filed: Dec. 2, 2024
(86) PCT No.: PCT/CN2024/136074

§ 371 Date: Dec. 3, 2025

(30) Foreign Application Priority Data
Apr. 17, 2024 (CN) 202410462654.X

(51) Int. Cl. G06F 3/0484

(52) U.S. Cl. CPC G06F 3/0484

(57) ABSTRACT

The present disclosure relates to an interaction method, an electronic device, a storage medium and a program product, and relates to the field of terminal technologies. The interaction method includes: displaying, in a playing interface of multimedia content of a first user, information of a resource to be claimed; displaying a claiming result interface in response to a resource claiming operation of a second user; and displaying, in the claiming result interface, information of a live streaming room in response to the resource to be claimed being associated with the live streaming room.

### CROSS-REFERENCE TO RELATED APPLICATION(S)

The present application is based on and claims priority of China Application No. 202410462654.X, filed on Apr. 17, 2024, the disclosure of which is hereby incorporated by reference in its entirety.

### TECHNICAL FIELD

The present disclosure relates to the field of terminal technologies, and in particular, to an interaction method, an electronic device, a storage medium, and a program product.

### BACKGROUND

In some user-generated content applications, a user may create multimedia content, upload the multimedia content to the applications, and publish the multimedia content, and the published multimedia content may be browsed by other users. For example, in a video stream application, some users may create multimedia content such as videos and picture-text content, and publish them to a video stream. Moreover, when browsing the video stream, a user of this application may browse multimedia content published by a plurality of users through operations such as switching. If a user is interested in multimedia content published by other users, the user may interact in an area related to the multimedia content, for example, publish comments or give a like to the multimedia content.

### SUMMARY

The part of the summary is provided so as to introduce concepts in a brief form, and these concepts will be described in detail in the following part of detailed description. The part of the summary is not intended to identify key features or necessary features of the claimed technical solutions, nor is intended to limit the scope of the claimed technical solutions required.

According to some embodiments of the present disclosure, an interaction method is provided, including: displaying, in a playing interface of multimedia content of a first user, information of a resource to be claimed; displaying a claiming result interface in response to a resource claiming operation of a second user; and displaying, in the claiming result interface, information of a live streaming room in response to the resource to be claimed being associated with the live streaming room.

According to some embodiments of the present disclosure, an interaction method is provided, including: displaying a resource configuration interface in response to a first user configuring a resource to be distributed for multimedia content of the first user; displaying, in the resource configuration interface, a live streaming room association option and an input control for a resource amount of the resource, wherein the live streaming room association option is used to indicate that the resource to be distributed carries information of a live streaming room; and creating the resource to be distributed based on a selection result of the first user for the live streaming room association option and the resource amount input by the first user.

According to some embodiments of the present disclosure, an electronic device is provided, including: a memory; and a processor coupled to the memory, and the processor is configured to, based on instructions stored in the memory, execute the interaction method of any one of the embodiments described in the present disclosure.

According to some embodiments of the present disclosure, a computer-readable storage medium is provided, having a computer program stored thereon, and when the program is executed by a processor, the method of any one of the embodiments described in the present disclosure is executed.

According to some embodiments of the present disclosure, a computer program product is provided, and when the computer program product runs on a computer, the computer is caused to implement the method of any one of the embodiments described in the present disclosure.

According to some embodiments of the present disclosure, a computer program is provided, including: instructions, and when the instructions are executed by a processor, the processor is caused to execute the method of any one of the embodiments described in the present disclosure.

Other features, aspects, and advantages of the present disclosure will become clear through the following detailed description of the exemplary embodiments of the present disclosure with reference to the drawings.

### BRIEF DESCRIPTION OF THE DRAWINGS

Preferred embodiments of the present disclosure are described hereinafter with reference to the drawings. The drawings described herein are used to provide a further understanding of the present disclosure, and together with the following specific description, are incorporated in and constitute a part of this specification for explaining the present disclosure. It should be understood that the drawings in the following description only relate to some embodiments of the present disclosure, rather than limiting the present disclosure. In the drawings:

FIG. 1 shows a schematic flowchart of an interaction method according to some embodiments of the present disclosure.

FIG. 2 shows a schematic diagram of a multimedia content playing interface according to some embodiments of the present disclosure.

FIG. 3 shows a schematic diagram of a resource claiming interface according to some embodiments of the present disclosure.

FIGS. 4A and 4B show schematic diagrams of a claiming result interface according to some embodiments of the present disclosure.

FIG. 5 shows a schematic flowchart of an interaction method according to some other embodiments of the present disclosure.

FIGS. 6A and 6B show schematic diagrams of a playing interface of multimedia content of a first user on a client of the first user.

FIG. 7 shows a schematic diagram of a resource configuration interface according to some embodiments of the present disclosure.

FIG. 8 shows a schematic structural diagram of an interaction apparatus according to some embodiments of the present disclosure.

FIG. 9 shows a schematic structural diagram of an interaction apparatus according to some other embodiments of the present disclosure.

FIG. 10 shows a schematic structural diagram of an electronic device according to some embodiments of the present disclosure.

FIG. 11 shows a schematic structural diagram of a computer system according to some embodiments of the present disclosure.

It should be understood that, for the convenience of description, the sizes of various parts shown in the drawings are not necessarily drawn in a real proportional relationship. The same or similar reference numbers are used in the drawings to denote the same or similar components. Therefore, once an item is defined in one drawing, it may not be further discussed in subsequent drawings.

### DETAILED DESCRIPTION OF EMBODIMENTS

The technical solutions in the embodiments of the present disclosure are described clearly and completely hereinafter with reference to the drawings in the embodiments of the present disclosure, but apparently, the described embodiments are merely some rather than all of the embodiments of the present disclosure. The following description of the embodiments is actually only illustrative, and in no way serves as any limitation on the present disclosure and its application or use. It should be understood that the present disclosure may be implemented in various forms, and should not be construed as being limited to the embodiments set forth herein.

It should be understood that steps described in method implementations of the present disclosure may be performed in different orders and/or in parallel. Moreover, the method implementations may include additional steps and/or omit performing illustrated steps. The scope of the present disclosure is not limited in this regard. Unless otherwise specifically stated, relative arrangements, numerical expressions, and numerical values of components and steps set forth in these embodiments are to be construed as merely exemplary, and do not limit the scope of the present disclosure.

The term “include/comprise” and its variants used in the present disclosure mean open terms that at least include elements/features mentioned hereinafter, but do not exclude other elements/features, that is, “include/comprise but not limited to”. Moreover, the term “contain” and its variants used in the present disclosure mean open terms that at least contain elements/features mentioned hereinafter, but do not exclude other elements/features, that is, “contain but not limited to”. Therefore, include/comprise is synonymous with contain. The term “based on” means “based at least in part on”.

The phrases “an embodiment”, “some embodiments”, or “embodiments” throughout the specification mean that a specific feature, structure, or characteristic described in conjunction with the embodiments is included in at least one embodiment of the present disclosure. For example, the term “an embodiment” means “at least one embodiment”, the term “another embodiment” means “at least one another embodiment”, and the term “some embodiments” means “at least some embodiments”. Moreover, appearances of the phrase “in an embodiment”, “in some embodiments”, or “in embodiments” in various places throughout the specification are not necessarily all referring to the same embodiment, but may also refer to the same embodiment.

It should be noted that concepts such as “first” and “second” mentioned in the present disclosure are merely used to distinguish between different apparatuses, modules, or units, and are not used to limit an order or interdependence of functions performed by these apparatuses, modules, or units. Unless otherwise specified, the concepts of “first”, “second”, etc. are not intended to imply that objects so described must be in a given order temporally, spatially, in ranking, or in any other manner.

It should be noted that modifications of “an” and “a plurality of” mentioned in the present disclosure are illustrative rather than restrictive, and those skilled in the art should understand that unless clearly indicated in the context, they should be understood as “one or more”.

The names of messages or information exchanged between a plurality of apparatuses in the implementations of the present disclosure are only used for illustrative purposes, and are not used to limit the scope of these messages or information.

Embodiments of the present disclosure are described in detail hereinafter with reference to the drawings, but the present disclosure is not limited to these specific embodiments. The following specific embodiments may be combined with each other, and the same or similar concepts or processes may not be repeated in certain embodiments. Moreover, in one or more embodiments, a specific feature, structure, or characteristic may be combined in any suitable manner that will be clear to those of ordinary skill in the art from the present disclosure.

In a multimedia application, when a viewer is interested in browsed multimedia content, the viewer may interact with a publisher of the multimedia content, for example, comment or give a like. In the case where the viewer has a very strong interest in the multimedia content, the viewer may actively view other interfaces related to the publisher, for example, view a homepage of the publisher, browse other multimedia content of the publisher, and so on.

In addition to publishing and browsing of multimedia content, some applications also provide a live streaming function, for example, a user may publish one or more pieces of multimedia content in a multimedia feed, and during some periods of time, the user may also open a live streaming room to interact with more users through live streaming.

Through analysis, it is found that interaction between the viewer and the publisher needs to be actively initiated by the viewer, and in most cases, the viewer needs to be driven by an interest degree of the viewer in the multimedia content to initiate the interaction. Therefore, many users may not interact due to reasons such as unskilled operations and weak interaction willingness. Further, if the viewer wants to enter the live streaming room of the publisher, more operations are required. Therefore, when browsing the multimedia feed, the probability that a user will actively access the live streaming room is low. Therefore, there is a need to provide a solution for increasing the traffic of the live streaming room, that is, a solution for diverting the browsing traffic of the multimedia content to the live streaming room.

In Internet applications, some users may create resources and distribute the resources to other users. After other users claim the resources, the resources are transferred from the account of the user who distributes the resources to the account of the user who claims the resources. For example, a user may distribute resources in a chat interface with other users to increase intimacy and interest between the users.

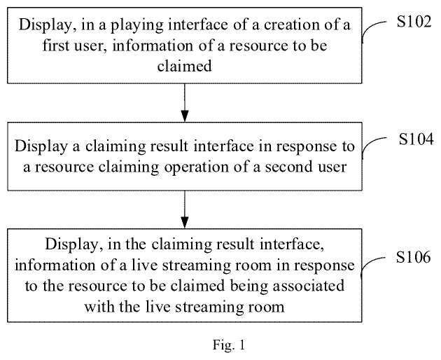

Embodiments of the present disclosure expand the resource distribution and claiming functions. On the one hand, in a resource distribution scenario, the resource distribution is associated with certain multimedia content. On the other hand, when a viewer of the multimedia content claims the resource, information of a live streaming room is displayed, so as to guide the viewer of the multimedia content to access the live streaming room through the resource, thereby increasing the traffic of the live streaming room. An embodiment of the interaction method of the present disclosure is described hereinafter with reference to FIG. 1.

FIG. 1 shows a schematic flowchart of an interaction method according to some embodiments of the present disclosure. The embodiment involves a first user who distributes a resource and a second user who claims the resource, and the embodiment may be executed on a client of the second user. As shown in FIG. 1, the interaction method of this embodiment includes steps S102 to S106.

In step S102, information of a resource to be claimed is displayed in a playing interface of multimedia content of a first user.

The multimedia content of the first user refers to multimedia content created, edited, or uploaded by the first user, and the multimedia content is published under an account of the first user. The multimedia content includes, for example, a video, picture-text content, and picture-text notes, and so on.

The resource to be claimed is a resource created by the first user, such as a red envelope and a virtual item, and so on. The process of creating the resource by the first user will be further described below.

The information of the resource to be claimed is used to describe the resource to be claimed, so as to guide a user to claim the resource. The information of the resource to be claimed may be a claiming control (such as a button) and a link of the resource to be claimed, and so on. The claiming control may be provided with description information, such as “red envelope for followers or subscribers”, and so on. In some embodiments, in response to a triggering operation on the triggering control, the resource claiming process may be executed. The information of the resource to be claimed may also be other information, such as description information, which will not be repeated here.

The information of the resource to be claimed may be displayed to all viewers, or may be displayed to a specific user, such as a follower of the first user and a friend of the first user, according to the settings of the first user. The information of the resource to be claimed may be displayed in response to the playing of the multimedia content of the first user, or may be displayed after the multimedia content of the first user is played for a specified duration, which may be selected by those skilled in the art as needed.

In step S104, a claiming result interface is displayed in response to a resource claiming operation of a second user.

The claiming result interface and the playing interface of the first multimedia content may be displayed on the same page, for example, the playing interface of the multimedia content may be displayed in a reduced size to provide display space for the claiming result interface. In this way, the second user may observe the claiming result, and may also continue to watch the multimedia content at the same time. Alternatively, after the second user claims the resource, the playing interface of the multimedia content may be switched to the claiming result interface.

Information of the resource claimed by the second user may be displayed in the claiming result interface. The resource claimed by the second user may be the entire resource to be claimed or a part of the resource to be claimed. The information of the resource claimed by the second user may include a resource amount of the resource claimed by the second user, a source of the resource (that is, the first user), and so on.

In step S106, information of a live streaming room is displayed in the claiming result interface in response to the resource to be claimed being associated with the live streaming room.

When publishing the resource to be claimed, the first user may set whether the resource to be claimed is associated with a live streaming room. In the case where the resource to be claimed is associated with the live streaming room, the information of the live streaming room may be displayed to guide the second user to enter the live streaming room.

The live streaming room associated with the resource may also be referred to as a live streaming room to be recommended. In some embodiments, the live streaming room is a live streaming room of the first user or a live streaming room of another user other than the first user. The live streaming room of another user may be a live streaming room recommended by a follower or subscriber of the first user, a live streaming room of a contact of the first user, or a live streaming room associated with the multimedia content in step S102, and so on. For example, if the multimedia content is an introduction of an item, the live streaming room associated with the multimedia content may be a shopping live streaming room, and the item is included in a commodity list of the shopping live streaming room.

The information of the live streaming room includes, for example, an entry control of the live streaming room, a name of the live streaming room, a description of the live streaming room, a current state of the live streaming room, or a multimedia resource of the live streaming room, and so on.

The entry control of the live streaming room may directly provide the second user with a way to access the live streaming room. For example, in response to a triggering operation of the second user on the entry control, an interface of the live streaming room is displayed. In some embodiments, the entry control of the live streaming room may be displayed based on the state of the live streaming room, for example, in the case where the live streaming room is in a live streaming state, the entry control of the live streaming room is displayed, and in the case where the live streaming room is not in a live streaming state, the entry control of the live streaming room is not displayed.

The multimedia resource of the live streaming room may be presented in the form of an image, a video, or the like. The image of the live streaming room is, for example, a cover of the live streaming room, an image of a host of the live streaming room, a screenshot of historical content of the live streaming room, and so on. The video of the live streaming room is, for example, a recommended video of the live streaming room or a preview stream of the live streaming room, and so on. The preview stream may be a pre-recorded video, a historical video clip of the live streaming room, or a video clip of a current live streaming. In this way, the second user may know the situation of the live streaming room more directly through the multimedia resource of the live streaming room.

The current state of the live streaming room includes, for example, whether the live streaming room is in a live streaming state. In some embodiments, in response to the live streaming room being in a live streaming state, the information of the live streaming room may include an identification indicating that the live streaming room is in the live streaming state, for example, an identification of “live streaming”. In response to the live streaming room not being in the live streaming state, the information of the live streaming room may include an identification indicating that the live streaming room is not in the live streaming state, such as “live streaming has not started” and “live streaming has ended”, or in this case, the information of the live streaming room may not include state information.

Through the above embodiments, the resource to be claimed is displayed in association with the multimedia content of the first user, so that the resource may be distributed through the multimedia content, and the coverage of the resource to be claimed is improved. Moreover, when the second user claims the resource, the information of the live streaming room may be quickly obtained. Therefore, the multimedia content of the first user and the live streaming room to be recommended may be associated through the resource, the efficiency of guiding the traffic of the multimedia content of the first user to the live streaming room is improved, and the traffic of the live streaming room is also increased.

The resource claiming process is exemplarily described below with reference to some schematic interface diagrams.

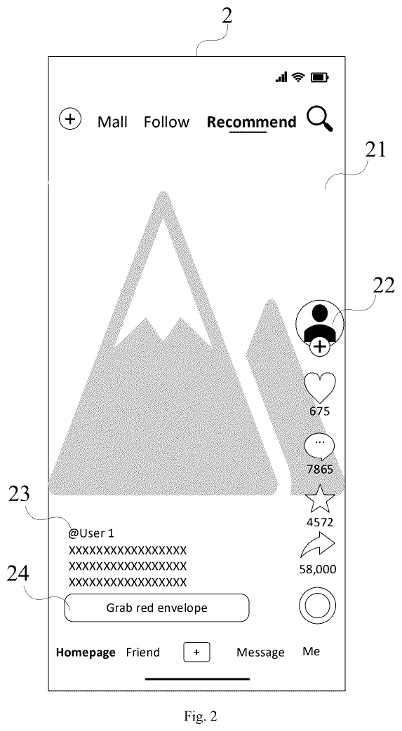

FIG. 2 shows a schematic diagram of a multimedia content playing interface according to some embodiments of the present disclosure. As shown in FIG. 2, the playing interface 2 of this embodiment includes multimedia content 21 being played, such as a video. The playing interface 2 may optionally include an avatar 22 and a name 23 of a publisher user 1 (that is, the first user) of the multimedia content 21. The playing interface 2 also includes a claiming control 24 of the resource to be claimed. This interface may be displayed on a client of a user 2. In response to the user 2 (that is, the second user) triggering the claiming control 24, the resource claiming process may be triggered.

In some embodiments, after the second user triggers the claiming control of the resource to be claimed, the second user may be asked through the resource claiming interface to confirm again whether to claim the resource. In response to the triggering operation of the second user on the claiming control, the resource claiming interface is displayed, and in the resource claiming interface, the claiming result interface is displayed in response to the confirmation operation of the second user.

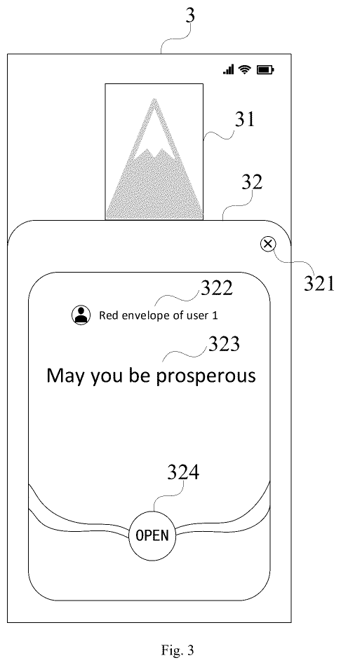

FIG. 3 shows a schematic diagram of a resource claiming interface according to some embodiments of the present disclosure. As shown in FIG. 3, the interface 3 includes a playing interface 31 of multimedia content and the resource claiming interface 32, which are arranged vertically in the interface 3, so that the user 2 may continue to watch the multimedia content while viewing the information of the resource. The resource claiming interface 32 may also be displayed full screen as needed, which is not limited in the present disclosure.

In the resource claiming interface 32, a cancel control 321 may be displayed, and in response to the user 2 triggering the cancel control 321, the resource claiming interface 32 may be closed, for example, returning to the interface 2 shown in FIG. 2.

In the resource claiming interface 32, a source description 322 of the resource may also be displayed, such as “red envelope of user 1”, to indicate that the resource is created and distributed by the user1; in addition, a postscript 323 of the resource may also be displayed, such as “May you be prosperous”, which is added by the user 1 when creating the resource. The shading of the resource claiming interface 32 may also be displayed according to the settings of the user1. For example, the user 1 may select a cover style (such as selecting a “red envelope cover”) of the resource when creating the resource.

In the resource claiming interface 32, a confirm control 324 is also displayed. In response to the triggering operation of the user 2 on the confirm control 324, the resource claiming process of the user 2 is executed, that is, the resource claimed by the user 2 is transferred to the account of the user 2. Then, the claiming result interface may be displayed.

It should be clear to those skilled in the art that some embodiments of the present disclosure may not include the resource claiming interface. For example, after the second user triggering the claiming control 24 in the interface 2, the claiming result interface may also be directly displayed.

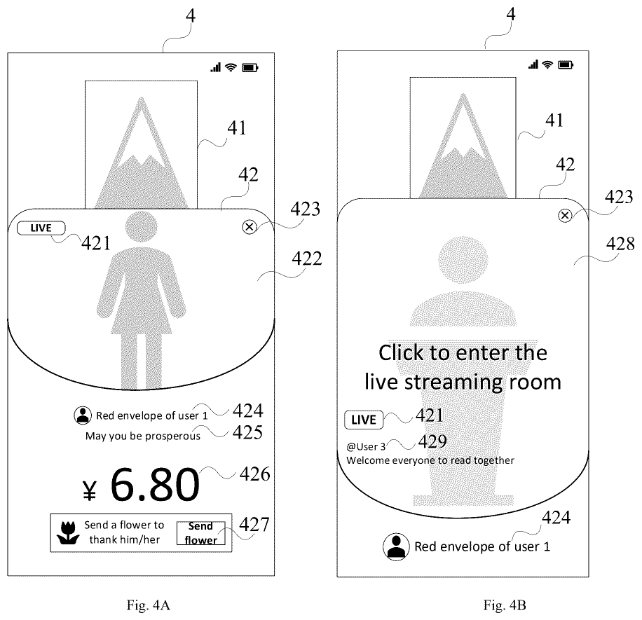

FIGS. 4A and 4B show schematic diagrams of a claiming result interface according to some embodiments of the present disclosure. As shown in FIG. 4A, the interface 4 includes a playing interface 41 of multimedia content and the claiming result interface 42, which are arranged vertically in the interface 4, so that the user 2 may continue to watch the multimedia content while viewing the resource claiming result. The claiming result interface 42 may also be displayed full screen as needed, which is not limited in the present disclosure.

In some embodiments, in response to the live streaming room being in a live streaming state, a cover of the live streaming room and an identification indicating that the live streaming room associated with the resource is in the live streaming state are displayed in the claiming result interface. For example, in the example shown in FIG. 4A, the information of the live streaming room includes an identification 421 indicating that the live streaming room is in a live streaming state and an image 422 of the live streaming room, and the image 422 is, for example, the cover of the live streaming room.

If the user 2 does not want to continue to access the live streaming room, user 2 may trigger a closing control 423 to close the claiming result interface 42, for example, returning to the interface 2 shown in FIG. 2.

The claiming result interface 42 shown in FIG. 4A displays the information of the live streaming room more concisely. In some embodiments, more information of the live streaming room, such as a preview stream of the live streaming room, may be further displayed. The process of switching from the cover of the live streaming room to the preview stream may be manually triggered or automatically triggered by the second user.

In some embodiments, in response to a first operation of the second user on the cover, the cover is switched to the preview stream of the live streaming room, where the preview stream is the entry control of the live streaming room. For example, in response to the user 2 performing an downward swiping operation or a clicking operation on the cover of the live streaming room, the preview stream of the live streaming room may be displayed. The cover of the live streaming room in FIG. 4A may further include guidance information such as “pull down to view” and “click to view” to guide the user 2 to further view. After the first operation is performed, the interface may be as shown in FIG. 4B.

In some embodiments, the cover is switched to the preview stream of the live streaming room in response to the display duration of the cover of the live streaming room reaching a threshold. Therefore, the cover may be automatically switched to the preview stream. The interface after automatic switching may also be as shown in FIG. 4B.

In FIG. 4B, the preview stream 428 of the live streaming room is displayed in the claiming result interface 42, so that the user 2 may know the content of the live streaming room in more detail. The preview stream 428 serves as the entry of the live streaming room, and after the user 2 triggers (for example, clicks on) the preview stream, the interface of the live streaming room may be displayed. “Click to enter the live streaming room” may be displayed on an upper layer of the preview stream 428 to guide the user 2 to enter the live streaming room. In some embodiments, the information of the live streaming room includes at least one of a name of a host of the live streaming room or a description of the live streaming room. For example, the claiming result interface 42 may further display other information 429 of the live streaming room, such as the host user 3 of the live streaming room and an introduction of the live streaming room “welcome everyone to read together”, and so on.

In some embodiments, the cover is located in an information display area of the claiming result interface, and the information display area is expanded in response to the first operation of the second user on the cover, and in the expanded information display area, the cover is switched to the preview stream of the live streaming room. As shown in FIGS. 4A and 4B, the area occupied by the preview stream 428 in FIG. 4B is larger than the area occupied by the image 422. Therefore, the preview stream with more information and richer content may be displayed in a larger size, which is convenient for the second user to browse.

Certainly, the above embodiments are only one implementation. If required, the live streaming room may also be entered in response to the user 2 triggering the cover of the live streaming room. That is, the cover may also serve as the entry control of the live streaming room. In addition to the cover and the preview stream, the entry control may also be in other forms, which will not be repeated here.

The claiming result interface 42 may also include a source description 424 of the resource “red envelope of user 1” to illustrate that the resource comes from the user 1; and may also include a postscript 425 “May you be prosperous”. In addition, the claiming result interface 42 also includes a resource amount 426 claimed by the user 2, and in this example, the user 2 claims 6.8 yuan.

In addition to using the distributed resource to guide the second user to enter the live streaming room, some embodiments of the present disclosure may also use the distributed resource to guide the second user to interact with the first user about the multimedia content published by the first user. In some embodiments, an interactive control is displayed in the claiming result interface, and a virtual item is sent to the first user or a comment is published for the multimedia content of the first user in response to a triggering operation of the second user on the interactive control,.

Taking FIG. 4A as an example, the claiming result interface 42 may also include an interactive control 427. In response to the user 2 triggering the interactive control 427, a virtual flower may be sent to the multimedia content of the user 1 through the account of the user 2. In some embodiments, if the interactive control user triggers a comment function, a comment input control of the multimedia content of the first user is displayed in response to the second user triggering the interactive control, so that the second user may quickly post comments on the multimedia content of the first user.

In some embodiments of the present disclosure, in response to the resource to be claimed being associated with a live streaming room, in the case where the live streaming room is in a live streaming state, information of the live streaming room is displayed in the claiming result interface, and in the case where the live streaming room is not in a live streaming state, the information of the live streaming room is not displayed in the claiming result interface. In the case where the live streaming room is not in the live streaming state, since the live streaming room cannot be entered at this time, this method may reduce the display of irrelevant information to the second user. However, some embodiments of the present disclosure may still display other information other than the entry control of the live streaming room, such as a name of a host of the live streaming room, a description of the live streaming room, a start time of the live streaming room, or a reservation control of the live streaming room, even when the live streaming room is not in a live streaming state, so that the second user may know more information about the live streaming room and then enter the live streaming room to browse after the live streaming room is live streamed.

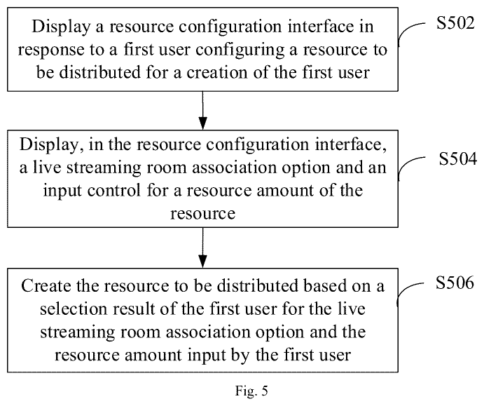

An embodiment of the present disclosure further provides an interaction method for creating a resource. FIG. 5 shows a schematic flowchart of an interaction method according to some other embodiments of the present disclosure. As shown in FIG. 5, the interaction method of this embodiment includes steps S502 to S506. This embodiment may be executed by a client of a first user.

In step S502, a resource configuration interface is displayed in response to the first user configuring a resource to be distributed for multimedia content of the first user. Information of the resource will be displayed on a playing interface of the multimedia content.

In some embodiments, in the playing interface of the multimedia content of the first user, the resource configuration interface is displayed in response to the first user triggering a resource distribution control. Therefore, the resource to be distributed is automatically associated with the multimedia content.

In step S504, a live streaming room association option and an input control for a resource amount of the resource are displayed in the resource configuration interface, where the live streaming room association option is configured to indicate that the resource to be distributed carries information of a live streaming room.

The first user may decide whether to select the live streaming room association option. In response to the first user selecting the live streaming room association option, the resource to be distributed may carry the information of the live streaming room; and in response to the first user not selecting the live streaming room association option, the resource to be distributed does not carry the information of the live streaming room.

The input control of the resource amount may include a total amount of the resource, a number of distribution portions of the resource (that is, a maximum number of users who may claim the resource), a resource amount in each portion of the resource, and so on.

In step S506, the resource to be distributed is created based on a selection result of the first user for the live streaming room association option and the resource amount input by the first user. After the creation is completed, the resource to be distributed may be displayed in association with the multimedia content of the first user, and the resource to be distributed corresponds to the resource to be claimed in the foregoing embodiments.

The above embodiment may provide an option of whether to associate a live streaming room when the first user creates a resource. Therefore, the first user may create a resource that is associated with both the multimedia content of the first user and the live streaming room to be recommended. Therefore, the resource may be distributed through the multimedia content, and the coverage of the resource to be claimed is improved. Moreover, when the second user claims the resource, the information of the live streaming room may be quickly obtained. Therefore, the multimedia content of the first user and the live streaming room to be recommended may be associated through the resource, the efficiency of guiding the traffic of the multimedia content of the first user to the live streaming room is improved, and the traffic of the live streaming room is also increased.

In some embodiments, in the playing interface of the multimedia content of the first user, the resource configuration interface is displayed in response to the first user triggering a resource distribution control. Therefore, the first user may create resource associated with the multimedia content when viewing the multimedia content published by the first user.

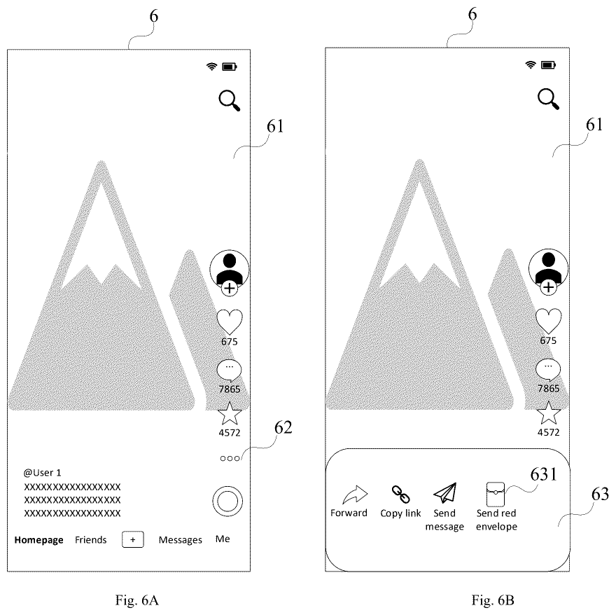

FIGS. 6A and 6B show schematic diagrams of a playing interface of multimedia content of a first user on a client of the first user. As shown in FIG. 6A, the playing interface 6 includes multimedia content 61, and also includes a function control for likes, comments, and the like and an extended function control 62, where the extended function control 62 is used to carry functions not directly displayed in the playing interface 6. In response to triggering the extended function control 62, the playing interface 6 presents the effect in FIG. 6B, that is, the display of a function panel 63 is triggered. The function panel 63 may include a resource distribution control 631, such as a “send red envelope” function. In response to triggering the resource distribution control 631, the resource configuration interface may be displayed. Certainly, FIGS. 6A and 6B are only exemplary, and the resource distribution control 631 may also be directly set on the playing interface 6 or displayed through other means as needed, which is not limited in the present disclosure.

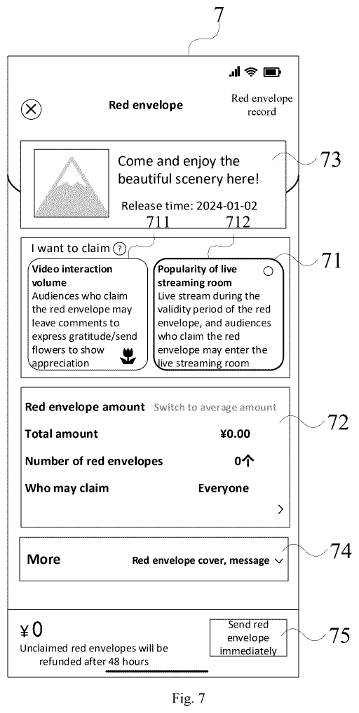

FIG. 7 shows a schematic diagram of a resource configuration interface according to some embodiments of the present disclosure. As shown in FIG. 7, the resource configuration interface 7 includes an option component 71 and an input component 72 of the resource amount.

In some embodiments, an interactive association option is displayed in the resource configuration interface, where the interactive association option is configured to indicate that the resource to be distributed carries an interactive control, and the interactive control is used to trigger an interaction between a user browsing the multimedia content and the first user. For example, the option component 71 exemplarily includes an interactive association option 711. In response to the first user selecting the interactive association option 711 and creating the resource, when other users claim the resource, the claiming result interface will include an interactive control. If the interactive association option 711 is not selected, when other users claim the resource, the claiming result interface does not include the interactive control.

The option component 71 also includes a live streaming room association option 712, and the first user may determine whether the resource to be distributed carries information of a live streaming room by selecting or not selecting this option.

The input component 72 may include one or more input controls, such as a total quantity (total amount) of the resource, a number of portions of the resource (number of red envelopes), and a claiming permission of the resource (who may claim), and so on.

In some embodiments, information of the multimedia content of the first user is displayed in the resource configuration interface, so as to reflect the association between the resource and the multimedia content of the first user. As shown in FIG. 7, the playing interface 7 may also include information 73 of the multimedia content, which includes, for example, a cover, a title, and a publication time of the multimedia content, and so on. In this way, during the process of the user creating the resource, the association between the resource and the user's creation is more clearly indicated.

In some embodiments, the playing interface 7 may also include other configuration controls 74, which are used, for example, to set a style of the resource to be distributed and add a postscript, and so on.

In some embodiments, the playing interface 7 may also include a resource creation control 75. In response to triggering the resource creation control 75, the resource to be distributed is created based on the selection result of the first user for the live streaming room association option and the resource amount input by the first user.

The embodiments of the interaction method of the present disclosure are introduced above. The apparatuses or devices for implementing the methods of the above embodiments are described below.

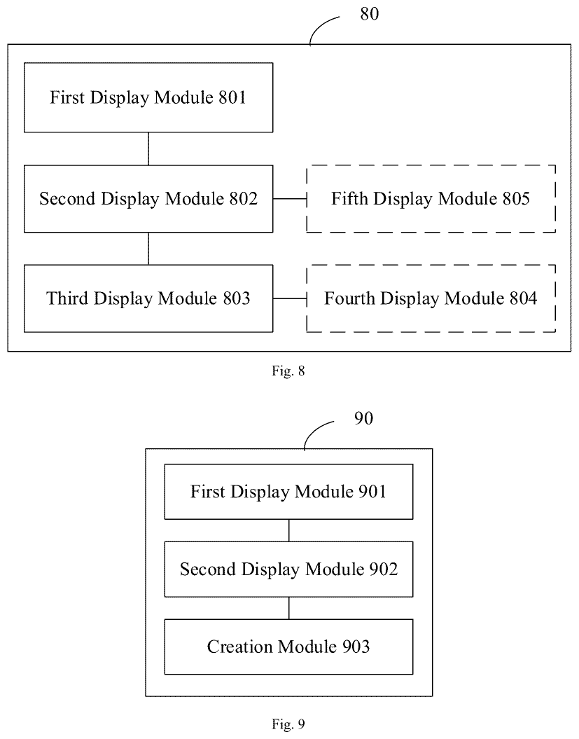

FIG. 8 shows a schematic structural diagram of an interaction apparatus according to some embodiments of the present disclosure. The interaction apparatus of this embodiment is located, for example, on a client of a second user. As shown in FIG. 8, the interaction apparatus 80 of this embodiment includes: a first display module 801, which is configured to display information of a resource to be claimed in a playing interface of multimedia content of a first user; a second display module 802, which is configured to display a claiming result interface in response to a resource claiming operation of a second user; and a third display module 803, which is configured to display information of a live streaming room in the claiming result interface in response to the resource to be claimed being associated with the live streaming room.

In some embodiments, the information of the live streaming room includes an entry control of the live streaming room, and the interaction apparatus 80 also includes a fourth display module 804, which is configured to display an interface of the live streaming room in response to a triggering operation of the second user on the entry control.

In some embodiments, the information of the live streaming room includes a preview stream of the live streaming room.

In some embodiments, the information of the live streaming room includes an identification indicating that the live streaming room is in a live streaming state.

In some embodiments, the information of the live streaming room includes a cover and a preview stream of the live streaming room, and the third display module 803 is further configured to: display the cover of the live streaming room and an identification indicating that the live streaming room is in the live streaming state in the claiming result interface in response to the live streaming room being in the live streaming state; and switch the cover to the preview stream of the live streaming room in response to a first operation of the second user on the cover, where the preview stream is an entry control of the live streaming room.

In some embodiments, the cover is located in an information display area of the claiming result interface, and the third display module 803 is further configured to: expand the information display area in response to the first operation of the second user on the cover; and switch the cover to the preview stream of the live streaming room in the expanded information display area.

In some embodiments, the third display module 803 is further configured to switch the cover to the preview stream of the live streaming room in response to a display duration of the cover of the live streaming room reaching a threshold.

In some embodiments, the information of the live streaming room includes at least one of a name of a host of the live streaming room or a description of the live streaming room.

In some embodiments, the first display module 801 is further configured to display a claiming control of the resource to be claimed in the playing interface of the multimedia content of the first user.

In some embodiments, the second display module 802 is further configured to: display a resource claiming interface in response to a triggering operation of the second user on the claiming control; and display the claiming result interface in response to a confirmation operation of the second user in the resource claiming interface.

In some embodiments, the interaction apparatus 80 also includes: a fifth display module 805, which is configured to display an interactive control in the claiming result interface, and send a virtual item to the first user or publish a comment for the multimedia content of the first user in response to a triggering operation of the second user on the interactive control,.

FIG. 9 shows a schematic structural diagram of an interaction apparatus according to some other embodiments of the present disclosure. The interaction apparatus of this embodiment may be located on a client of a first user. As shown in FIG. 9, the interaction apparatus 90 of this embodiment includes: a first display module 901, which is configured to display a resource configuration interface in response to a first user configuring a resource to be distributed for multimedia content of the first user; a second display module 902, which is configured to display, in the resource configuration interface, a live streaming room association option and an input control for a resource amount of the resource, where the live streaming room association option is configured to indicate that the resource to be distributed carries information of a live streaming room; and a creation module 903, which is configured to create the resource to be distributed based on a selection result of the first user for the live streaming room association option and the resource amount input by the first user.

In some embodiments, the second display module 902 is further configured to display information of the multimedia content of the first user in the resource configuration interface.

In some embodiments, the second display module 902 is further configured to display an interactive association option in the resource configuration interface, where the interactive association option is configured to indicate that the resource to be distributed carries an interactive control, and the interactive control is configured to trigger an interaction between a user browsing the multimedia content and the first user.

In some embodiments, the first display module 901 is further configured to display the resource configuration interface in response to the first user triggering a resource distribution control in a playing interface of the multimedia content of the first user.

It should be noted that the above units are only logic modules divided according to specific functions implemented by them, and are not used to limit specific implementations, for example, they may be implemented by software, hardware, or a combination of software and hardware. In an actual implementation, the above units may be implemented as independent physical entities, or may be implemented by a single entity (for example, a processor (CPU or DSP, etc.), an integrated circuit, etc.). Moreover, the above units are indicated by dotted lines in the drawings to indicate that these units may not actually exist, and the operations/functions implemented by them may be implemented by a processing circuit itself.

Moreover, although not shown, the apparatus may also include a memory, which may store various information generated in operations by the apparatus and units included in the apparatus, programs and data for the operations, data to be sent by a communication unit, and so on. The memory may be a volatile memory and/or a non-volatile memory. For example, the memory may include but be not limited to a random access memory (RAM), a dynamic random access memory (DRAM), a static random access memory (SRAM), a read-only memory (ROM), and a flash memory. Certainly, the memory may also be located outside the apparatus. Optionally, although not shown, the apparatus may also include the communication unit, which may be used to communicate with other apparatuses. In an example, the communication unit may be implemented in any suitable manner known in the art, for example, including communication components such as an antenna array and/or a radio frequency link, various types of interfaces, communication units, and so on. Details are not described herein again. Moreover, the apparatus may also include other components not shown, such as a radio frequency link, a baseband processing unit, a network interface, a processor, and a controller, and so on. Details are not described herein again.

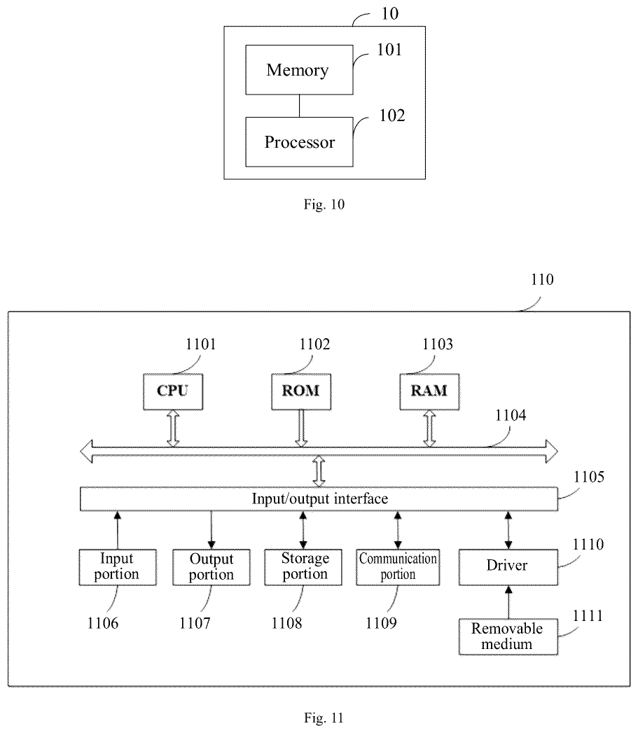

Some embodiments of the present disclosure also provide an electronic device. FIG. 10 shows a schematic structural diagram of an electronic device according to some embodiments of the present disclosure. For example, in some embodiments, the electronic device 10 may be various types of devices, for example, may include but be not limited to mobile terminals such as a mobile phone, a notebook computer, a digital broadcast receiver, a PDA (personal digital assistant), a PAD (tablet computer), a PMP (portable multimedia player), and an in-vehicle terminal (such as an in-vehicle navigation terminal), and fixed terminals such as a digital TV and a desktop computer. For example, the electronic device 10 may include a display panel, which is used to display data and/or execution results used in the solution of the present disclosure. For example, the display panel may be various shapes, such as a rectangular panel, an elliptical panel, or a polygonal panel. In addition, the display panel may not only be a flat panel, but may also be a curved panel or even a spherical panel.

As shown in FIG. 10, the electronic device 10 of this embodiment includes: a memory 101 and a processor 102 coupled to the memory 101. It should be noted that components of the electronic device 10 shown in FIG. 10 are only exemplary and non-restrictive, and the electronic device 10 may also have other components according to actual application needs. The processor 102 may control other components in the electronic device 10 to perform desired functions.

In some embodiments, the memory 101 is configured to store one or more computer-readable instructions. The processor 102 is configured to, when running the computer-readable instructions, implement the method according to any one of the above embodiments when the computer-readable instructions are run by the processor 102. For the specific implementation and related explanation content of each step of the method, reference may be made to the above embodiments, and the repeated parts are not described herein again.

For example, the processor 102 and the memory 101 may directly or indirectly communicate with each other. For example, the processor 102 and the memory 101 may communicate through a network. The network may include a wireless network, a wired network, and/or any combination of a wireless network and a wired network. The processor 102 and the memory 101 may also communicate with each other through a system bus, which is not limited in the present disclosure.

For example, the processor 102 may be embodied as various appropriate processors, processing apparatuses, etc., such as a central processing unit (CPU), a graphics processing unit (Graphics Processing Unit, GPU), a network processor (NP), etc.; or may be a digital signal processor (DSP), an application specific integrated circuit (ASIC), a field programmable gate array (FPGA) or other programmable logic devices, a discrete gate or transistor logic device, or a discrete hardware component. The central processing unit (CPU) may have an X86 or ARM architecture or the like. For example, the memory 101 may include any combination of various forms of computer-readable storage media, such as a volatile memory and/or a non-volatile memory. For example, the memory 101 may include a system memory, which stores, for example, an operating system, an application, a boot loader (Boot Loader), a database, and other programs. Various applications, various data, and the like may also be stored in the storage medium.

In addition, according to some embodiments of the present disclosure, in the case where various operations/processes according to the present disclosure are implemented by software and/or firmware, a program constituting the software may be installed from a storage medium or a network to a computer system having a dedicated hardware structure, for example, a computer system 110 shown in FIG. 11, and the computer system may perform various functions, including the functions as described above, when installed with various programs. FIG. 11 shows a schematic structural diagram of a computer system according to some embodiments of the present disclosure.

In FIG. 11, a central processing unit (CPU) 1101 performs various processes according to a program stored in a read-only memory (ROM) 1102 or a program loaded from a storage part 1108 into a random access memory (RAM) 1103. In the RAM 1103, data required when the CPU 1101 performs various processes is also stored according to needs. The central processing unit is only exemplary, and it may also be other types of processors, such as various processors as described above. The ROM 1102, the RAM 1103, and the storage part 1108 may be various forms of computer-readable storage media, as described below. It should be noted that although the ROM 1102, the RAM 1103, and the storage apparatus 1108 are shown separately in FIG. 11, one or more of them may be combined or located in the same or different memories or storage modules.

The CPU 1101, the ROM 1102, and the RAM 1103 are connected to each other via a bus 1104. An input/output interface 1105 is also connected to the bus 1104.

The following parts are connected to the input/output interface 1105: an input part 1106, such as a touch screen, a touchpad, a keyboard, a mouse, an image sensor, a microphone, an accelerometer, and a gyroscope; an output part 1107, including a display, such as a cathode ray tube (CRT) and a liquid crystal display (LCD), a speaker, a vibrator, etc. ; the storage part 1108, including a hard disk, a magnetic tape, etc. ; and a communication part 1109, including a network interface card, such as a LAN card and a modem. The communication part 1109 allows communication processing to be performed via a network such as Internet. It is easy to understand that although various apparatuses or modules in the computer system 110 are shown in FIG. 11 to communicate through the bus 1104, they may also communicate through a network or other means, where the network may include a wireless network, a wired network, and/or any combination of a wireless network and a wired network.

According to needs, a driver 1110 is also connected to the input/output interface 1105. A removable medium 1111 such as a magnetic disk, an optical disc, a magneto-optical disc, a semiconductor memory, or the like is installed on the driver 1110 according to needs, so that a computer program read therefrom is installed into the storage part 1108 according to needs.

In the case where the above series of processes are implemented by software, a program constituting the software may be installed from a network such as Internet or a storage medium such as the removable medium 1111.

According to the embodiments of the present disclosure, the process described above with reference to the flowchart may be implemented as a computer software program. For example, the embodiments of the present disclosure include a computer program product, which includes a computer program carried on a computer-readable medium, where the computer program contains program codes for performing the method shown in the flowchart. In such an embodiment, the computer program may be downloaded and installed from a network through the communication apparatus 1109, or installed from the storage apparatus 1108, or installed from the ROM 1102. When the computer program is executed by the CPU 1101, the above functions defined in the method of the embodiments of the present disclosure are executed.

It should be noted that in the context of the present disclosure, the computer-readable medium may be a tangible medium, which may contain or store a program for use by or in combination with an instruction execution system, apparatus, or device. The computer-readable medium may be a computer-readable signal medium, a computer-readable storage medium, or any combination of the above two. The computer-readable storage medium may be, for example, but not limited to: an electrical, magnetic, optical, electromagnetic, infrared, or semiconductor system, apparatus, or device, or any suitable combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as a part of a carrier wave, and computer-readable program codes are carried therein. This propagated data signal may take many forms, including but not limited to, an electromagnetic signal, an optical signal, or any suitable combination of the above. The computer-readable signal medium may also be any computer-readable medium other than the computer-readable storage medium, and the computer-readable signal medium may send, propagate, or transmit a program used by or in combination with an instruction execution system, apparatus, or device. The program codes contained on the computer-readable medium may be transmitted by any suitable medium, including but not limited to: a wire, an optical cable, an RF (radio frequency), etc., or any suitable combination of the above.

The above computer-readable medium may be included in the above electronic device, or may exist alone without being assembled into the electronic device.

In some embodiments, there is also provided a computer program, including: instructions, which when executed by a processor, cause the processor to execute the method of any one of the above embodiments. For example, the instructions may be embodied as computer program codes.

In the embodiments of the present disclosure, computer program codes for performing the operations of the present disclosure may be written in one or more programming languages or a combination thereof, where the above programming languages include but are not limited to object-oriented programming languages, such as Java, Smalltalk, and C++, and also include conventional procedural programming languages, such as “C” language or similar programming languages. The program codes may be executed entirely on a user computer, partly on the user computer, as a stand-alone software package, partly on the user computer and partly on a remote computer, or entirely on the remote computer or a server. In the case of involving the remote computer, the remote computer may be connected to the user computer through any kind of network (including a local area network (LAN) or a wide area network (WAN)), or may be connected to an external computer (for example, connected by using Internet provided by an Internet service provider).

The flowchart and block diagrams in the drawings illustrate the architecture, functionality, and operation of possible implementations of the systems, methods and computer program products according to various embodiments of the present disclosure. In this regard, each block in the flowchart or block diagrams may represent a module, a program segment, or a portion of code that includes one or more executable instructions for implementing a specified logical function. Furthermore, it should be noted that, in some alternative implementations, functions indicated in the blocks may occur in an order different from that indicated in the drawings. For example, two blocks shown in succession may, in fact, be executed substantially concurrently, or the blocks may sometimes be executed in a reverse order, depending upon the functionality involved. It also should be noted that each block of the block diagrams and/or flowchart, and combinations of blocks in the block diagrams and/or flowchart, may be implemented by special purpose hardware-based systems that perform specified functions or operations, or combinations of special purpose hardware and computer instructions.

The modules, components, or units involved in the embodiments of the present disclosure may be implemented by software or by hardware, where names of the modules, components, or units do not constitute a limitation on the modules, components, or units per se under certain circumstances.

The foregoing functions described herein may be performed at least in part by one or more hardware logic components. For example, without limitation, exemplary hardware logic components that may be used include: a field programmable gate array (FPGA), an application specific integrated circuit (ASIC), an application specific standard product (ASSP), a system on chip (SOC), a complex programmable logical device (CPLD), and so on.

The above description only shows some embodiments of the present disclosure and illustrates technical principles employed. Those skilled in the art should understand that the scope of disclosure involved in the present disclosure is not limited to the technical solutions formed by specific combinations of the above technical features, and should also cover other technical solutions formed by any combination of the above technical features or their equivalent features without departing from the above disclosed concept, for example, a technical solution formed by replacing the above features with technical features with similar functions disclosed in the present disclosure (but not limited thereto).

In the description provided herein, numerous specific details are set forth. However, it is understood that embodiments of the present disclosure may be implemented without these specific details. In other instances, well-known methods, structures, and techniques have not been shown in detail to avoid obscuring an understanding of this description.

Moreover, although the operations are depicted in a particular order, this should not be construed as requiring that the operations should be performed in a specific order as illustrated or in a sequential order. Under certain circumstances, multitasking and parallel processing may be advantageous. Similarly, although the above discussion includes several specific implementation details, these should not be construed as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although some specific embodiments of the present disclosure have been described in detail by way of examples, those skilled in the art should understand that the above examples are only for illustration, and are not intended to limit the scope of the present disclosure. Those skilled in the art should understand that the above embodiments may be modified without departing from the scope and spirit of the present disclosure. The scope of the present disclosure is defined by the appended claims.

1. An interaction method, comprising:
displaying, in a playing interface of multimedia content of a first user, information of a resource to be claimed;
displaying a claiming result interface in response to a resource claiming operation of a second user; and
displaying, in the claiming result interface, information of a live streaming room in response to the resource to be claimed being associated with the live streaming room.

2. The interaction method of claim 1, wherein the information of the live streaming room comprises an entry control of the live streaming room, and the interaction method further comprises:
displaying an interface of the live streaming room in response to a triggering operation of the second user on the entry control.

3. The interaction method of claim 1, wherein the information of the live streaming room comprises a preview stream of the live streaming room.

4. The interaction method of claim 1, wherein the information of the live streaming room comprises an identification indicating that the live streaming room is in a live streaming state.

5. The interaction method of claim 1, wherein the information of the live streaming room comprises a cover and a preview stream of the live streaming room, and the displaying, in the claiming result interface, the information of the live streaming room comprises:
displaying, in the claiming result interface, the cover of the live streaming room and an identification indicating that the live streaming room is in the live streaming state, in response to the live streaming room being in the live streaming state; and
switching the cover to the preview stream of the live streaming room in response to a first operation of the second user on the cover, wherein the preview stream is an entry control of the live streaming room.

6. The interaction method of claim 5, wherein the cover is located in an information display area of the claiming result interface, and the switching the cover to the preview stream of the live streaming room in response to a first operation of the second user on the cover comprises:
expanding the information display area in response to the first operation of the second user on the cover; and
switching the cover to the preview stream of the live streaming room in the expanded information display area.

7. The interaction method of claim wherein the displaying, in the claiming result interface, the information of the live streaming room further comprises:
switching the cover to the preview stream of the live streaming room in response to a display duration of the cover of the live streaming room reaching a threshold.

8. The interaction method of claim 1, wherein the information of the live streaming room comprises at least one of a name of a host of the live streaming room or a description of the live streaming room.

9. The interaction method of claim 1, wherein the displaying, in the playing interface of the multimedia content, the information of the resource to be claimed comprises:
displaying, in the playing interface of the multimedia content, a claiming control of the resource to be claimed.

10. The interaction method of claim 9, wherein the displaying the claiming result interface in response to a resource claiming operation of a second user comprises:
displaying a resource claiming interface in response to a triggering operation of the second user on the claiming control; and
displaying the claiming result interface in response to a confirmation operation of the second user in the resource claiming interface.

11. The interaction method of claim 1, wherein the live streaming room is a live streaming room of the first user or a live streaming room of a user other than the first user.

12. The interaction method of claim 1, further comprising:
displaying an interactive control in the claiming result interface; and
sending a virtual item to the first user or publishing a comment for the multimedia content of the first user in response to a triggering operation of the second user on the interactive control.

13. An interaction method, comprising:
displaying a resource configuration interface in response to a first user configuring a resource to be distributed for multimedia content of the first user;
displaying, in the resource configuration interface, a live streaming room association option and an input control for a resource amount of the resource, wherein the live streaming room association option is configured to indicate that the resource to be distributed carries information of a live streaming room; and
creating the resource to be distributed based on a selection result of the first user for the live streaming room association option and the resource amount input by the first user.

14. The interaction method of claim 13, further comprising:
displaying, in the resource configuration interface, information of the multimedia content of the first user.

15. The interaction method of claim 13, further comprising:
displaying an interactive association option in the resource configuration interface, wherein the interactive association option is configured to indicate that the resource to be distributed carries an interactive control, and the interactive control is configured to trigger an interaction between a user browsing the multimedia content and the first user.

16. The interaction method of claim 12, wherein the displaying a resource configuration interface in response to a first user configuring a resource to be distributed for multimedia content of the first user comprises:
displaying the resource configuration interface in response to the first user triggering a resource distribution control in a playing interface of the multimedia content of the first user.

17. An electronic device, comprising:
at least one memory; and
at least one processor coupled to the memory, the processor being configured to, based on instructions stored in the memory, execute an interaction method comprising:
displaying, in a playing interface of multimedia content of a first user, information of a resource to be claimed;
displaying a claiming result interface in response to a resource claiming operation of a second user; and
displaying, in the claiming result interface, information of a live streaming room in response to the resource to be claimed being associated with the live streaming room.

18. A non-transitory computer-readable storage medium having a computer program stored thereon, wherein the interaction method of claim 1 is implemented when the program is executed by a processor.

19. (canceled)

20. (canceled)

21. An electronic device, comprising:
at least one memory; and
at least one processor coupled to the memory, the processor being configured to, based on instructions stored in the memory, execute the interaction method of claim 13.

22. A non-transitory computer-readable storage medium on which a computer program is stored, which when executed by a processor, cause the processor to implement the interaction method of claim 13.
